(19) United States
(12) Patent Application Publication
(10) Pub. No.: US 2024/0071186 A1
(43) Pub. Date: Feb. 29, 2024

(54) A SENSOR DEVICE, METHOD AND SYSTEM FOR DEFINING THE STATUS OF A TAGGED COMMODITY

(71) Applicant: FYGI TECHNOLOGIES AS, Mosa (NO)

(72) Inventors: Espen LIPPERT, Son (NO); Kenneth KRISTIANSEN, Dilling (NO)

(21) Appl. No.: 18/257,858

(22) PCT Filed: Dec. 17, 2021
(86) PCT No.: PCT/NO2021/050270

§ 371 Date: Jun. 15, 2023

(30) Foreign Application Priority Data
Dec. 18, 2020 (NO) 20201403

(51) Int. Cl. G07G 1/00; G06Q 20/20

(52) U.S. Cl. CPC G07G 1/009; G06Q 20/20

(57) ABSTRACT

The disclosure relates to a sensor device for defining the status of a tagged commodity comprising: a tag associated with a commodity, the tag comprising an article descriptor, an article list comprising article descriptor entries representing tagged commodities in the article list, and a tag reader for reading the tag of a tagged commodity, a decision module able to verify if the article descriptor of the read tag of a tagged commodity is present in the article list. The disclosure further relates to a method for verifying the status of a tagged commodity and a system for verifying the status of a tagged commodity.

### TECHNICAL FIELD

The present disclosure relates to a sensor device for defining the status of a tagged commodity characterized by, a method for verifying the status of a tagged commodity and a system for verifying the status of a tagged commodity. More specifically, the disclosure relates to a sensor device for defining the status of a tagged commodity, a method for verifying the status of a tagged commodity and a system for verifying the status of a tagged commodity as defined in the introductory parts of claim 1, claim 17 and claim 20.

### BACKGROUND ART

A problem with the solutions related to for example theft marking goods in outlets of the prior art is that systems make use of hardware that has to be dismounted or disabled when a customer purchases the goods. Typically a hardware dongle is pinned to the goods, and it has to be removed by physically using a tool (magnets in special holders). This is a cumbersome and expensive arrangement. Some more recent systems are using RFID devices that stays on the goods but has to be disabled using a specific reader/writer system operated by a shop worker. This is also a cumbersome and fault prone system, often leading to an alarm situation when customer leaves an outlet through alarm grids at exit caused by a faulty disabling process. There is thus a need for improved system that is easier and cheaper to maintain and less prone to faulty or wrongly operation causing false alarms. It is also a need for a system requiring fewer installations, and a system that is more adaptable to recent development for outlets enabling more self-service outlet points. Current techniques do not adapt well to for example purchase on net and pickup in outlet store.

### SUMMARY

It is an object of the present disclosure to mitigate, alleviate or eliminate one or more of the above-identified deficiencies and disadvantages in the prior art and solve at least the above mentioned problem.

One of the main goal for the present invention is to detect theft and enable paying customers to pay for theft-marked goods and leave the store without any action such as removing alarms, interact with self-checkout hardware or store employees.

According to a first aspect there is provided a sensor device for defining the status of a tagged commodity characterized by comprising: a tag associated with a commodity, the tag comprising an article descriptor, an article list comprising article descriptor entries representing tagged commodities in the article list, the sensor device comprising a tag reader for reading the tag of a tagged commodity, a decision module able to verify if the article descriptor of the read tag of a tagged commodity is present in the article list.

The basic idea of the present invention is to verify if a detected marked commodity/goods is present in a cleared list of commodity article descriptors. This may thus be achieved without needing to physically alter the tag of the commodity as will be discussed in detail below.

According to some embodiments, the sensor device comprises: a checkout module, wherein the checkout module provides the article descriptor entries representing tagged commodities in the article list, and the decision module is enabled to receive the article list from the checkout module.

Introducing a checkout module adapts the present invention to a shop/outlet environment, and opens up for using self-checkout modules.

According to some embodiments, the checkout module for processing tagged commodity being one or more of: —Point of Sales, automatic or manually operated—Smart phone application, APP, and, —E-commerce system.

According to some embodiments, the tag reader comprise one or more antennas for transmission and reception of signals to/from the tag of a tagged commodity.

Various arrangements of a tag reader may be adaptable to various shop/exit layouts.

According to some embodiments, the tag is one of: an RFID tag, an NFC tag, and a custom built radio communication chip, and the tag further comprise a unique tag id.

Making use of the latest development in tag technologies makes it possible to utilize both easy to manage and cheap to implement marking devices. Typically present invention will use a passive RFID tag, not needing other power supply than can be drawn from the signal sent by the tag reader.

According to some embodiments, the sensor device comprises: a whitelist that comprises entries of unique tag ids associated with article descriptors previously identified by a tag reader and have been verified being present in an associated article list.

Identification of all tagged commodities being cleared in a POS and detected by a tag reader will be stored in a whitelist, for disabling later detection causing raising alarms.

According to some embodiments, the decision module is enabled to verify, when an article descriptor of a read tag of a tagged commodity is identified not being present in the article list, whether the unique tag id is present in the whitelist.

Thus, enabling an outlet system to filter out only commodities/goods not paid for and moved out of shop/outlet exit.

According to some embodiments, the decision module and the whitelist resides in a remote processing resource, such as a cloud computer resource or a remote server, and the sensor device and the checkout module is in communication connection with the remote processing resource.

Using backend services for handling data processing enables the system to be more adaptable to larger outlet entities, store chains, shopping malls, web shops and others.

According to some embodiments, when a unique tag id of a read tag of a tagged commodity is verified being present in the article list, and the unique tag id is not present in the whitelist, the tag id is designated to a new list element in the whitelist.

Every approved commodity is entered into a whitelist if decision module decides that the commodity has been approved and being present in an article list, such that the commodity may freely be moved pass any tag reader repeatedly at later time without causing an alert to be raised.

According to some embodiments, the sensor device comprises: a decision module that comprises: a first compare module for deciding whether the read tag of a tagged commodity is not present in the article list, and/or a second compare for deciding whether the read tag of a tagged commodity is not present in the article list and the unique tag id of the read tag of a tagged commodity is not present in the whitelist.

Making a commodity having been identified to quickly be cleared for exit, with no alert being raised. If not cleared in first layer of check, a second level is activated to check if commodity has earlier been cleared. Both clearing stages may raise alerts representing initiation of various further actions.

According to some embodiments, the sensor device comprises an alarm device that comprises one or more of, but not limited to:
an audio alarm
a light alarm
a push warning,
a camera, and
a light projector.

Thus the sensor device may be enabled to raise a number of different alarm types, loud, visible and silent ones, to perform different purpose alerts, logs, and actions.

According to some embodiments, the compare modules may initiate an activation code for one or more of, but not limited to:
initiating a whitelist or article list check process
sounding an audio alarm,
activating a light alarm,
sending a push warning,
operating a camera, and
activating a light projector.

A variation of different alerts may be initiated simultaneously, in series or conditionally activated by outcome of other alert activities.

According to some embodiments, the light projector the sensor comprises a message projecting device.

Visual alerts may serve specific purposes of greeting customers or remind them on actions and other. Specific commercial messages may for example be displayed related to recent commodity purchase.

According to some embodiments, the tag reader is arranged to monitor an exit passage located downstream of the checkout module, such that a customer purchasing one or more tagged commodities must pass the checkout module before passing the tag reader.

Adapting physical layout to an outlet exit may aid in misuse and theft avoidance.

According to some embodiments, the decision module is enabled to receives data from remote sensor devices related to tag associated with a commodity being analyzed by the remote sensor device.

Each outlet exit may be in contact with a larger number of outlet systems, to avoid false alerts initiating unwanted activities. Thus a unified system for theft prevention may be adaptable to large outlet environments, such as shopping malls, city centers and other wherein a commodity may pass multiple tag readers able to detect a commodity not being cleared by outlet. If a thief manages to exit one outlet, he/she will cause an alert to be raised if passing through a second exit from in a different outlet, or alternatively at a gate of a shopping mall, pedestrian crossing or other.

According to some embodiments, the tag reader is arranged to hang above an exit passage and has a form and size easily spotted and identifiable by passing customers, such as for example, but not bound to:
a half cut upside down hanging spherical form,
tube like form.

A visible appearance may be an important feature to avoid unintentional passing through exits by honest customers. For example an easily recognized form, a light message, audio messages or other may be used to increase awareness of a customer.

According to a second aspect there is provided a method for verifying the status of a tagged commodity comprising the following steps:
using a sensor device according to any of the first aspect,
processing a tagged commodity by reading, by a tag reader, the article descriptor of a tag,
performing a first compare to decide whether the tag article descriptor is associated with an entry in an article list, and
update a first alert status for the read tag, to:
   active; if tag article descriptor is not found in the article list, and
   passive; if it is found in the article list.

According to some embodiments, the method comprises the further steps:
when the first alert status is active:
   performing a first compare to decide whether the tag id of the read tag with tag id entries in a whitelist, and
if read tag id is not found in the whitelist perform one or more of:
   set a second alert to active status, and
   activate one or more of, but not limited to:
      a silent alarm registration process,
      an audio alarm,
      a light alarm,
      a push warning,
      a camera, and
      a light projector.

According to some embodiments, the method the method comprises the further steps:
when the first alert status is passive:
   generate a new designated list elements 401 in a whitelist with the tag id of the read tag.

According to a third aspect there is provided a system for verifying the status of a tagged commodity comprising: a sensor device according to any of the first aspect.

According to some embodiments, the system comprises: a remote computer environment, being one of a remote server or a cloud computing system, and the remote computer environment being adapted to maintain an article list and/or a whitelist of processed tagged commodities and/or tags.

Effects and features of the second and third aspects are to a large extent analogous to those described above in connection with the first aspect. Embodiments mentioned in relation to the first aspect are largely compatible with the the second and third aspects.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### Terminology

The term “tag” is to be interpreted as any type of RFID, NFC module, radio chip, Bluetooth marking device, or other comprising an id used for electronically, radio frequency or magnetically marking a commodity, or device, or any part of any type of assembly or the like.

The term “POS” is to be interpreted as any type point of sales, smart phone purchasing app, web based outlet purchase checkout, web based order system, member coupon redemption system, or other similar.

The term “Outlet”, “shop”, “store” is to be interpreted as variations of environments wherein the invention is implemented. Example used is a clothes shop, but could just as well be a DIY building accessories shop, flower/garden outlet, large shopping mall with multiple shops, equipment rental outlet, and other.

The term “sensor device” is used to define the overall system of the invention, but will also in some paragraphs be used to identify the tag reader, the tag reader being a central module that may comprise many of the system features of the sensor device embedded.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 shows a block diagram according to a first embodiment of the present disclosure for standalone outlet implementation.

FIG. 2 shows a block diagram according to a second embodiment of the present disclosure comprising a backend service.

FIG. 3 shows the tagged commodity, the sensor device and outlet environment.

FIG. 4A shows a tag reader

FIG. 4B shows a single tag reader implemented over a typical exit area of an outlet/shop.

FIG. 4C shows a double tag reader implemented over a typical exit area of an outlet/shop.

FIG. 5 shows an example of text message displayed by sensor device on floor of exit area of outlet.

FIG. 6 illustrates example of article list and whitelist

FIGS. 7A and 7B shows an embodiment of the antenna with combined Tx/Rx configuration

FIG. 7C shows an embodiment of the antennas with separate Tx and Rx configurations.

FIG. 8 show san embodiment of the tag reader arranged for optimized detection of outgoing and ingoing customers.

FIG. 9 show the tag reader of FIG. 8 in an shop entry/exit area.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

The sensor device 1, the tag reader, the POS, and backend service are all based on electronic devices, and as such it shall be understood that any one is powered either by grid power or other chargeable power source, and communication modules for executing wired or wireless communication of any type may also be comprised even if not specifically discussed in the following.

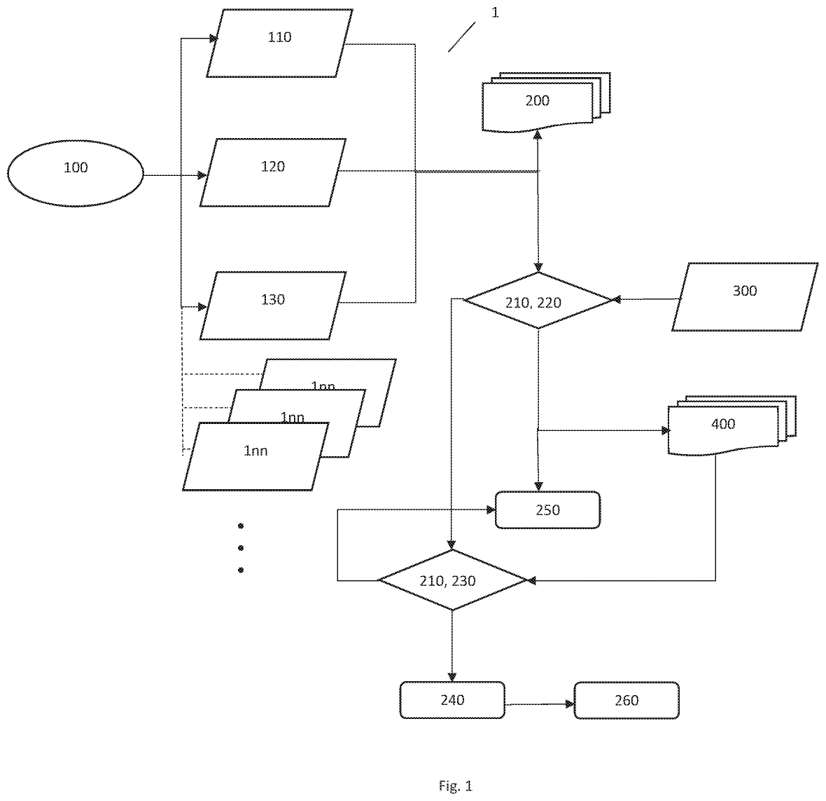

FIG. 1 shows a block diagram of an implementation of present invention wherein all data processing may be executed by the senor device and associated data files comprising information of commodities and tags. The scenario shows an embodiment of the sensor device 1 is installed for example in an outlet store for clothes. This embodiment is not dependent on a backend service operating continuously. The system may in fact be operated as a standalone entity without any backend service.

One data file type comprise lists of article descriptors being cleared to exit the stores. Each commodity/article 3 in the store is tagged by a tag 2 associated with a piece of commodity 3. The tag comprise information such as article descriptor 4 and tag id 5, where the tag id 5 is unique for every tag 2, and article descriptor 4 is used to identify the type of article 3. These article descriptors are related to the type of commodity, such as but not bound by price, brand, size, color and other features of a cleared, tagged or not tagged, commodity 3. Typically the process starts 100 by a customer bringing tagged commodities to a POS/smart phone app 110,120,130, 1nn using a sensor/reader, such as for example a photo/light sensor, or the like, reading an article descriptor 4 represented by a visual mark, barcode, QR code, image recognition (for example an AI module, not shown), or other. Normally, as it is with the present invention is that the POS/smart phone app 110,120,130, 1nn is not required to read the electronic tag 2 associated with the commodity 3, and an article descriptor list 200 is generated comprising article descriptor entries 201 for each purchase, time period, and/or collection of commodities 3 grouped by one or more of, but not limited to: associated commodities, commodities bagged together, commodities purchased by a defined group of customers, and others.

The first aspect of this disclosure shows a sensor device 1 for defining the status of a tagged commodity 3 characterized by comprising: a tag 2 associated with a commodity 3, the tag 2 comprising an article descriptor 4, an article list 200 comprising article descriptor 4 entries representing tagged commodities in the article list 200, the sensor device 1 comprising a tag reader 300 for reading the tag 2 of a tagged commodity 3, a decision module 210 able to verify if the article descriptor 4 of the read tag 2 of a tagged commodity 3 is present in the article list 200.

When the tag 2 is read by the tag reader 300, the tag transmits data comprising the article descriptor 4 stored in the tag 2 to the tag reader 300. The decision module 210 is able to receive the article list 200 comprising an entry for each validly entered commodity 3. The decision module is further able to continuously receive article descriptors 4 received from the tag reader 300 of commodities 3 passing the exit area covered by the tag reader 300. The decision module 210 then verifies whether the article descriptor 4 is present in available article lists 200. An article list 200 may administered according to local characteristics, such as timestamped and valid for a limited time period, checked out when all article descriptors 4 in the article list 200 has been verified exited by a tag reader, or other. If found, the decision module 210 acknowledges 250 that the commodity 3 in question may be free to exit, and/or for example indicate no-theft.

An article list 200 is generated based on entities of commodity/articles 3 registered typically at a POS (point of sale) 110, 120, 130, 1nn being one of but not limited to:
a smart phone based app 110 scanning a commodity/article by associated barcode, QR, number, text, icon or other
manual POS checkout 120
Automatic POS checkout 130

Typically one article list 200 is composed by a collection of commodities/articles associated with one customers purchase/payment at the POS 110, 120, 130 in a store.

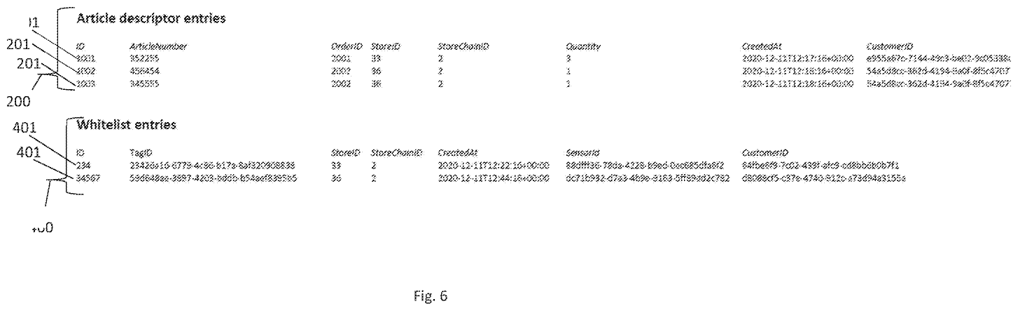

See FIG. 6 for examples of article descriptor entry 201 elements typically found in such article list 200. These elements may be one or more of, but not limited to: Article ID, Article number, Order ID, Store ID, Store chain ID, Quantity, Created time stamp, and Customer ID.

The customer may bring a collection of purchased commodities/articles 3 to a tag reader 300, typically arranged at an exit from the store. The tag reader 300 reads the tag of each commodity/article 3 and the tag reader 300 transmit the data read from the tags 2 to a decision module 210 of the sensor device 1. The decision module 210 then perform a first compare 220 of the article descriptors 4 read from the tags 2 with the content of the article list, and decides whether the article descriptors 4 of the commodities/articles 3 match the article descriptors 4 present in any of the article lists 200.

If the decision module 210 finds that some detected article descriptors 4 are not present in the article list 200, a second compare 230 is performed of the tag ids 5, read from the tags 2 corresponding to the tags having article descriptors 4 not found in the article list, with the content of one or more whitelists 400. The whitelists 400 being composed of earlier read tags 2, corresponding to the tags having article descriptors 4 found in an article list, and corresponding tag ids 5. If the tag id 5 of the tag 2 that did not have its article descriptor 4 in the article list 200 is found in the whitelist 400, then the second compare 230 will acknowledge 250 that the commodity 3 in question may be free to exit, and/or for example indicate no-theft, but if the tag id 5 of the tag 2 that did not have its article descriptor 4 in the article list 200 is not found in any whitelist 400, then the second compare 230 will raise an alert 240.

See FIG. 6 for examples of elements typically found in such Whitelist 400. These elements may be one or more of, but not limited to: ID, TagID, Store ID, Store chain ID, Created time stamp, Sensor ID, and Customer ID.

All article descriptors 4 analyzed in the first compare 220 that are present in the article list 200 will acknowledges 250 that the commodity 3 in question may be free to exit, and/or for example indicate no-theft, and further may initiate an update of the whitelist 400 which then will be provided with a new designated list elements 401 with tag ids 5 representing the tags 2 having article descriptors 4 found in the article list 200.

If an article descriptor 4 being evaluated in the decision module 210 not to belong to any entries in an article list 200, the decision module 210 may raise an alert. The alert raised by the decision module 210 may indicate a possible theft.

If an article descriptor 4 is received by the tag reader 200, and verified in an article list 200, but not found to be accompanied by associated article descriptors 4 found in the identified article list 200, an alert may be raised to indicate a possible theft. This way one can avoid that someone trying to exit with a commodity which has, by chance, a “valid” entry in an article list 200. The decision module 210 may implement an Artificial Intelligence, AI, routine or algorithm to, over time, improve the intelligence in detecting theft situations and avoid false positive and false negative alerts. A false positive alert is when an alert is raised, and there is no reason for raising such alert, and a false negative alert is that no alert is raised when it should be raised an alert.

The sensor further comprises: a checkout module 110,120,130, 1nn, wherein the checkout module 110,120,130 reads and provides the article descriptor 4 entries representing tagged commodities 3 in an article list 200, and the decision module 210 is enabled to receive the article list 200 from the checkout module 110,120,130, 1nn. It may be formulated that the checkout module 110,120,130, 1nn register and approves commodities 3 represented by their article descriptors 4. In this document a POS is typically a checkout module 110,120,130, 1nn.

The checkout module 110,120,130, 1nn for processing tagged commodity 3 may be any type of sales/checkout/cashier system, in traditional sales situation being one or more of:
Point of Sales, automatic 130 or manually 120 operated
Smart phone application 110, APP, and,
E-commerce system 1nn.

The checkout module may also be comprised of web based outlet purchase checkout, web based order system, member coupon redemption system, or other similar.

The tag reader 300 typically comprise two antennas 6A, 6B for transmission and reception of signals to/from the tag 2 of a tagged commodity 3 passing inside the reach of the antennas and tag 2. When two antennas 6A, 6B is in use the tag reader 300 comprise a tag movement analyzer module 270 having the ability to analyze signal strength and movement of the tag 2.

The tag 2 may be one of: an RFID tag, an NFC tag, and a custom built radio communication chip, the tag 2 further comprise a unique tag id 5, and the tag 2 is able to communicate the tag id 5 to the tag reader 300.

The tag id 5 and the article descriptor 4 may be transmitted to the tag reader in one and the same read operation. Both may be comprised in a data package being communicated from the tag 2 when passing a tag reader.

A typical use case for a paying customer would be to use a self-checkout solution (app using own smart phone), or the traditional PoS (Point of Sales), to pay for a product, and then leave the store. The product will be marked with a disposable RFID tag, and under the hood, the anti-theft system will silently allow the paying customer to leave the store with the paid-for goods.

The sensor device further comprises: a whitelist 400 comprising entries of unique tag ids 5 associated with article descriptors 4 previously identified by a tag reader 300 and have been verified being present in an associated article list 200.

In one embodiment, all tagged commodities 3 having been validly passed by a tag reader 300, in the past, will be registered and their unique tag id 5 is entered into a whitelist 400. There may be multiple whitelist.

The decision module 210 is enabled to verify, when an article descriptor 4 of a read tag 2 of a tagged commodity 3 is identified not being present in the article list 200, whether the unique tag id 5 is present in any of the available/relevant whitelists 400. Whitelists may be grouped by industry sector, commodity group, price group, country, geographical region, or other.

In practice this means that a since a tag 2 of a commodity 3 not necessarily is removed from the commodity 3 after being validly taken out of for example an outlet, it may well be brought pass a tag reader 300 at any time thereafter. Since the article descriptor 4 may then be read, and obviously the article descriptor is not found in a valid article list 200 initiating an alert, the tag reader 300 then reads/has read the unique tag id 5 of the tag 2. When this is checked towards the entries in relevant whitelist 400, it is found and alert is maintained.

A thief would be detected leaving the store with goods that aren't paid for and alert the store employees or guards using sound and light alarms. It will also send information about the ongoing theft over the air to employee or guard applications (for example a store employee smartphone app).

In a second embodiment of the sensor device 1 the decision module 210 and the whitelist 400 resides in a remote processing resource 500, such as a cloud computer resource or a remote server, and the sensor device 1 and the checkout module 110,120,130, 1nn is in communication connection with the remote processing resource 500.

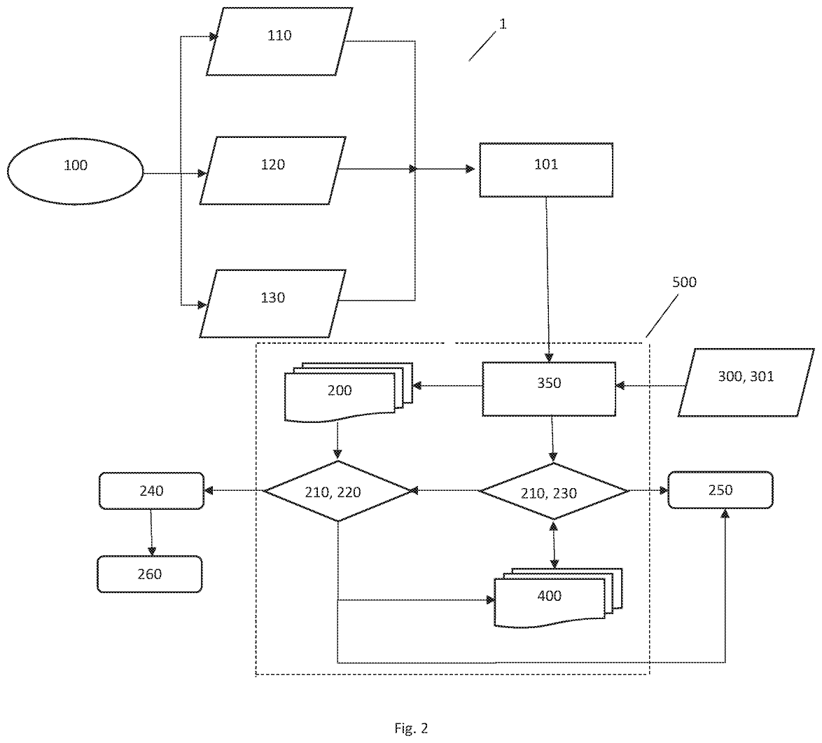

FIG. 2 describes one example of such an embodiment of wherein a backend service 500 is involved in data processing for the decision modules 210, as well as maintaining the article lists 200 and whitelists 400. The backend service 500 may reside on a cloud based service/server, a network server, a remote computer, a standalone computer or computer device, or other.

A first communication module 101 is provided in the sensor device 1 for communicating to a backend service 500 article descriptors 4 and optional meta data related to a checkout process, such as for example a time stamp and checkout type 110, 120, 130, 1nn.

A backend communication module 350 receives data from the first communication module 101 and from a second communication module 301 associated with the tag reader, wherein the second communication module 301 transmit data related to tag ids 5 and article descriptors 4 associated with the tag id 5 of the tags 2 detected by the tag reader.

The article lists 200 and the whitelists 400 may be maintained by the backend service 500, as well as the first and second compare modules 220, 230 of the decision module 210.

The decision module 210 communicates alerts back to the sensor device 1 for actions, such as raising an alert 240, or acknowledges 250 that the commodity 3 in question may be free to exit, and/or for example indicate no-theft.

When a unique tag id 5 of a read tag 2 of a tagged commodity 3 is verified being present in the article list 200, and the unique tag id 5 is not present in the whitelist 400, the tag id 5 is designated to a new list element 401 in the whitelist 400.

Now, having communicated all tag data 4, 5 to the remote processing service 500, the verification process may be turned to check ether the unique tag id 5 is present in a whitelist 400 first, and if it is not, check if the article descriptor is found in relevant article list 200. If found there, the unique tag id 5 is entered into relevant whitelist. If not found in either list 200, 400, and alert is returned to the sensor device 1.

The decision module 210 may in both embodiments comprise: a first compare module 220 for deciding whether the read tag of a tagged commodity is not present in the article list, and/or a second compare 230 for deciding whether the read tag 2 of a tagged commodity 3 is not present in the article list 200 and the unique tag id 5 of the read tag 2 of a tagged commodity 3 is not present in the whitelist 400.

The sensor device 1 may further comprise an alarm device 260 being composed of one or more of, but not limited to:
an audio alarm (306),
a light alarm (307),
a push warning (305),
a camera (305), and
a light projector (308).

Instead of or additionally to a camera (305) other resources and sensors may be used for observing or identify objects, persons and commodities, such resources may be, but are not limited to use of LIDAR, thermal sensors, ultrasound sensors and others.

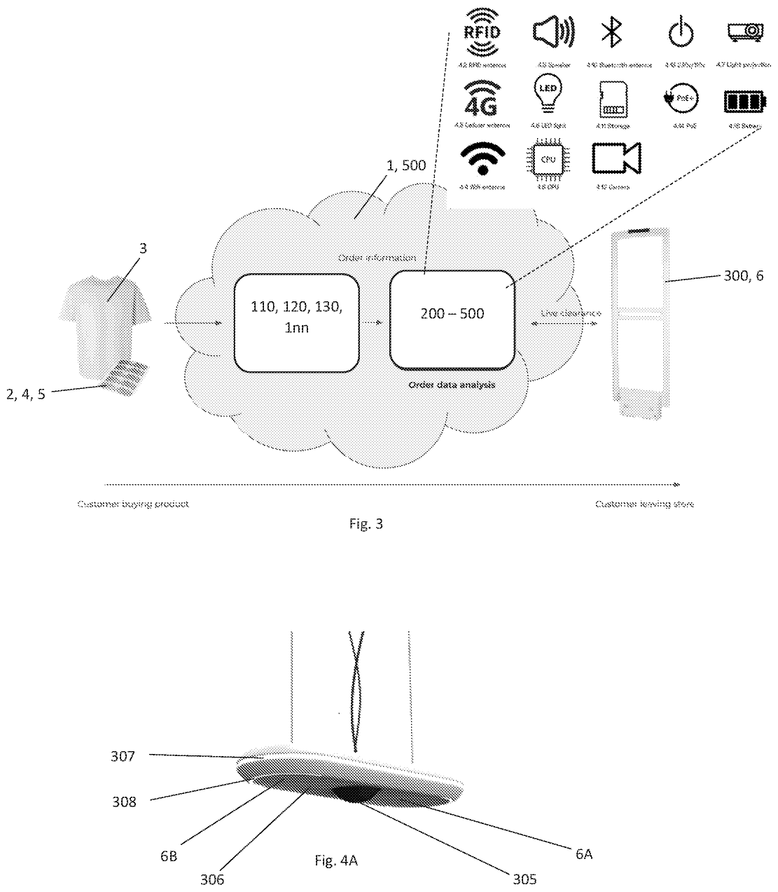

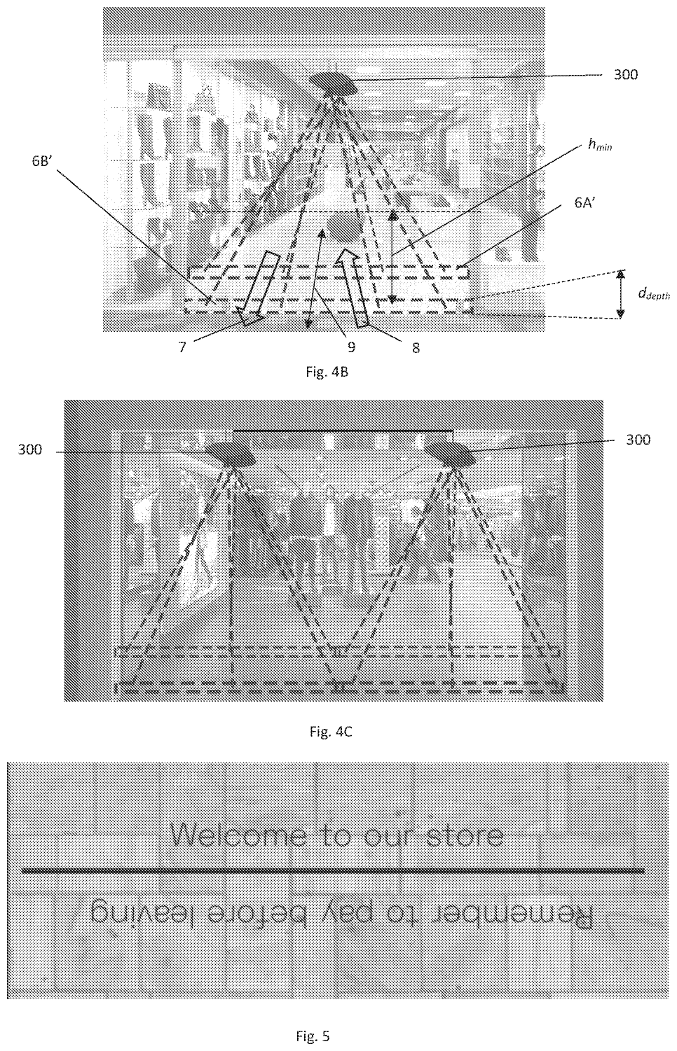

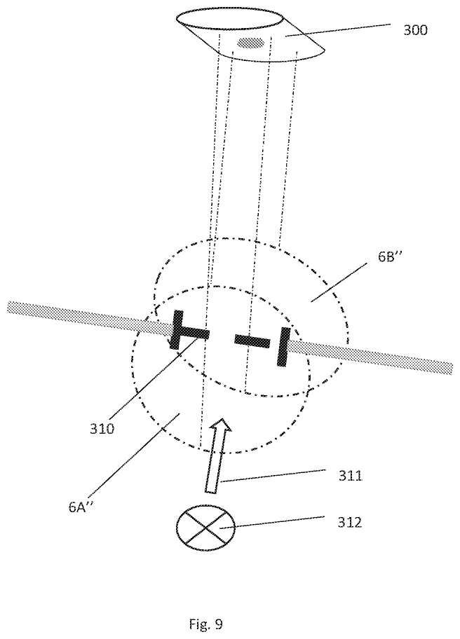

The compare modules 220,230 may initiate an activation code for one or more of, but not limited to:
initiating a whitelist 400 or article list 200 check process,
sounding an audio alarm 306,
activating a light alarm 307,
sending a push warning,
operating a camera 305, and
activating a light projector 308.
   An audio alarm 306 may be comprised inside the tag reader 300, or may be a standalone device for sounding one or more signals identifying that an alert has been raised. Various signal patterns and volumes may be provided to differentiate between warning types.
   A light alarm 307 may be comprised inside the tag reader 300, or may be a standalone device for emitting light signals identifying that an alert has been raised. Various light signal patterns, color and intensity may be provided to differentiate between alert types.
   A push warning transmission feature may be implemented in the tag reader 300 or in the sensor device. The function of this feature is to send push warnings or send data updates to databases keeping track of alerts, or simply send a text message (SMS) to a phone or communication device, for example carried by a security personnel, to indicate an alert has been raised. It is within the inventive scope of present invention to support push warning is several layers of importance.
   A camera 305 may be comprised inside the tag reader 300, or may be a standalone device for being activated/operated when an alert has been raised. A vide stream may then be transmitted to a backend or data storage for analysis. The camera may also be operating to be used with an image recognition module (not shown) in for example the task to identify commodity not being tagged, identify banned persons from entering a store, or for other surveillance operations. When including image recognition services in the sensor device system it may be advantageous to make use of Artificial intelligence on several layers that will be subject to the next generation development of the present invention.
   A light projector 308 may be comprised inside the tag reader 300, or may be a standalone device for being activated/operated when an alert has been raised to project a light message, see FIG. 5 for an example. The same feature may be used to display messages when movement is detected, continuously display messages, or use AI to analyze state/posture/gender of persons in the vicinity of the sensor device, and customize a message chosen based on result of the AI analysis output.
   Although the tag reader 300 is preferable implemented in a hanging device above the exit/entrance of a shop as seen in FIG. 4A-9, a further option is shown in FIG. 3 where the tag reader is arranged as a side mounted device at the exit/entrance. A combination (not shown) of overhanging and side mounted tag readers may also be provided. FIG. 3 further illustrates many of the features optionally implemented in the tag reader 300, which may be one or more of, but not limited to:
a wireless and/or wired communication module,
a microprocessor,
a camera,
a storage,
a battery and/or power source and/or power grid connection,
a projector,
a Bluetooth communication device,
one or more RFID reader/writer devices,
antennas to all communication modules,
power on/off remote and/or manual switch
Printed circuit boards comprising HW and SW to operate devices and system.
   It is foreseen that when the camera images are analyzed it may reveal for example age, gender, posture etc. of customer, and when purchase data for the same customer is recorded, it may be, over time and when considering the big data sets collected and analyzed, possible to predict various outcome of certain products and campaigns. Such data sets may itself be productized and formatted for various scenario. The light alarm/projectors 307, 308 typically serves different purpose, although they may also signal same signal to all.
   In one embodiment the light projector 308 is used to communicate alerts to the customer, and the alerts may signal one of but not limited to:
message to customer
idle
alarm
warning
OK/approved (good to go)
   In one embodiment the light alarm 307 is used to communicate alarms to the shop keepers, and the alarms may signal one of but not limited to:
message to shop keeper
idle
alarm
warning
OK/approved
   As an example the light projectors 308 may be configured to emit a warning when a customer moves close to the exit zone and the tag reader 300 detects a commodity not being checked out. It may then light n orange light on the floor, with an embedded message saying for example “remember to pay for the goods in your shopping basket, nearest checkout 5m”
   At the same time the light alarm 307 may be configured to emit a slowly flashing yellow light to allow the shop keeper to lend a watchful eye to the exit/entry.
   A possible action behavior of the sensor device is when an alert is raised, to notify a list of persons by a push message to multiple smartphones, computers, such that appropriate remedies may be taken. One could be to notify security personnel. An alert may initiate a no action even if there is detected a theft, depending on for example value of missing detected commodity 3. In such cases it may be sufficient to for example activate camera and storing images of person passing the sensor device, register the missing commodity 3, in a database, or other for example for later analysis, data processing and training of AI systems.

The light projector may comprise a message projecting device, for displaying messages for example on the floor, roof or wall close to the sensor device 1, for example the floor in an exit area of an outlet.

Typically, the tag reader is arranged to monitor an exit passage located downstream of the checkout module 110, 120, 130, 1nn such that a customer purchasing one or more tagged commodities 3 must pass the checkout module 110, 120, 130, 1nn before passing the tag reader 300.

Alternatively the outlet comprise multiple exits remote from several spaced apart checkout modules 110, 120, 130, 1nn, and the remote concept explained to FIG. 2 is more advantageously adapted.

The decision module may be enabled to receives data from remote sensor devices related to tag 2 associated with a commodity 3 being analyzed by the remote sensor device 1.

The tag reader 300 may be arranged to hang above an exit passage and have a form and size easily spotted and identifiable by passing customers, such as for example, but not limited to:
a half cut upside down hanging spherical form, and
a tube like form.

In one embodiment the sensor device is formed to be approx. 50 cm wide and with a 10-20 cm diameter, shaped as a cylinder, possibly painted in a easy identifiable pattern.

All commodities, in one embodiment of the present invention, in the store will be marked with disposable RFID tags. An order (purchase) of a product will be sent by the POS system to the a backend for live analysis. When for example an RFID marked product passes by the tag reader 300 unit, the tag reader 300 unit will immediately report the RFID tag 2 product information 4, 5 to the backend system 500. This is time critical, and system must be adapted to the small window of time when the customer leaves the store to be able to detect all commodities 3 brought within the reach of the tag reader 300 by the customer. The protocol of information exchange between the sensor device and the backend may be a REST API, or a continuously open socket stream giving low latency information exchange, or other standard or proprietary communication protocol supported in the industry.

The second aspect of this disclosure defines a method for verifying the status of a tagged commodity comprising the following steps:
using a sensor device the first aspect according to any of the first aspect to 16,
processing a tagged commodity 3 by reading, by a tag reader 300, the article descriptor 4 of a tag 2,
performing a first compare to decide whether the tag article descriptor is associated with an entry in an article list 200, and
update a first alert status for the read tag, to:
   active; if tag article descriptor 4 is not found in the article list 200, and
   passive; if it is found in the article list 200.

The method further comprises the steps:
when the first alert status is active:
   performing a first compare to decide whether the tag id 5 of the read tag 2 with tag id entries 401 in a whitelist 400, and
if read tag id 5 is not found in the whitelist 400 perform one or more of:
   set a second alert to active status, and
   activate one or more of:
      a silent alarm registration process,
      an audio alarm 306,
      a light alarm 307,
      a push warning,
      a camera 305, and
      a light projector 308.

The method may further comprises the steps:
when the first alert status is passive:
   generate a new designated list elements 401 in a whitelist 400 with the tag id 5 of the read tag 2.

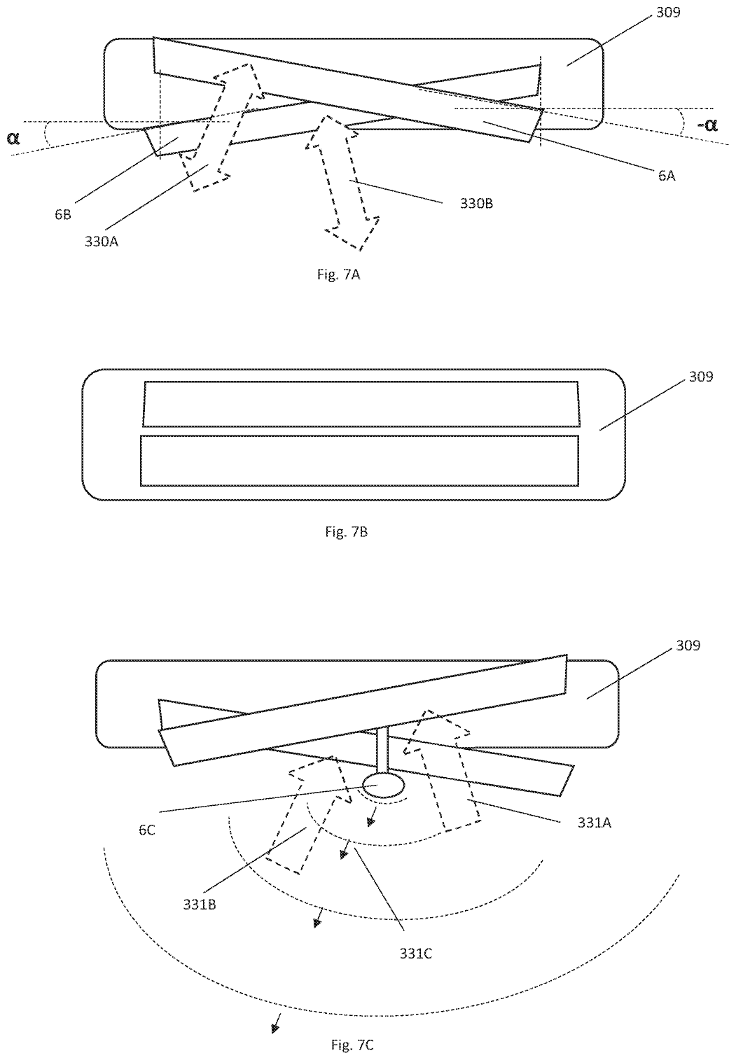

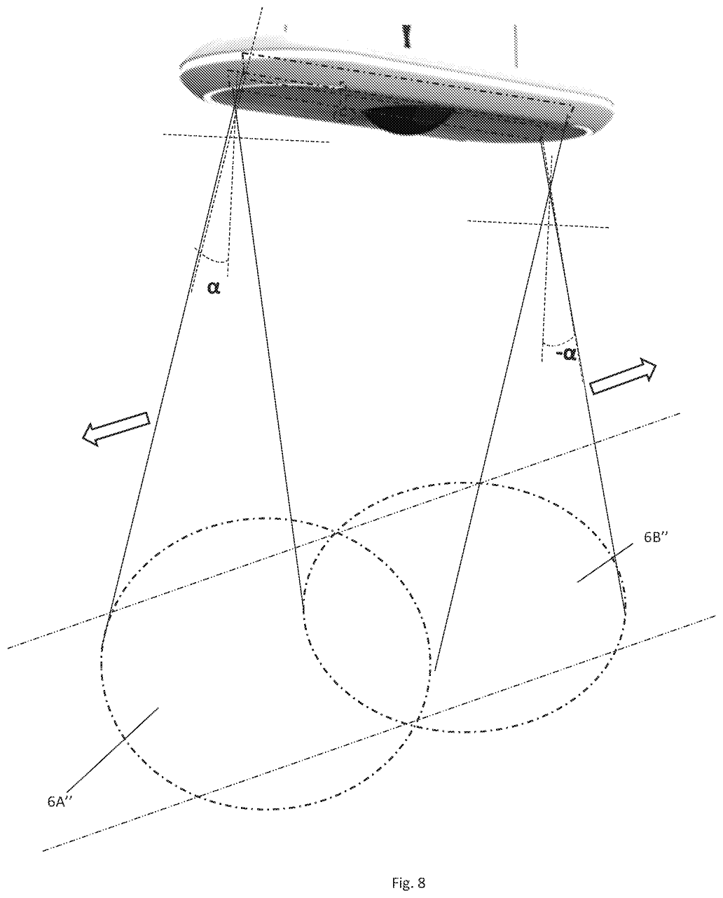

Sensor device 1 is advantageously comprising a variation of sensors and components, such as:
“Internet router”-PCB (Printed Circuit Board), having a Max size width and length, for example approx. 250 mm wide and 150 mm long. Variations may apply in accordance with available space and technology,
Device provided for indoor or outdoor usage,
   The antennas 6A, 6B may be of linear or circular polarization type, or other, in order to detect tags in desired directions and orientation. It should be powerful enough to cover a defined area 6A′, 6B′, and detect tags with bags, boxes, with humans in-between antennas and tag. The range of the antennas should be able to track RFID tags within a store entrance. The entrance area width may for example be defined to be 100 cm to 800 cm, with a needed height hₘᵢₙ for example of at least 150 cm over the entire area.
   The tag reader may comprise multiple antennas, for example 2 antennas 6A, 6B in a “dual” antenna implementation as indicated in the FIGS. 4B and 4C, wherein when the dual antenna 6A, 6B is applied, the reach of the antenna may overlap in some sectors and not overlap in other to enable a first antenna 6A to detect a moving tag 2 of a commodity 3 within the antenna signal cone 6A′. When a second antenna 6B detect the same moving tag 2 of a commodity 3 within the antenna signal cone 6B′, it may be possible to define the movement direction, speed and other characteristics of the movement pattern of the moving tag 2 of a commodity 3. Movement pattern may be one of but not limited to: quick movement exiting the sensor area in an out direction 7, quick movement entering the sensor area in an in direction 8, uneven movement pattern without single direction, static non-moving.
   This is further exemplified in the FIGS. 7A, 7B and 7C, wherein the dual antenna is shown as directional antennas arranged to provide a footprint different of each other shifted in the longitudinal direction/path through the exit passage. In the figures only the antennas and the back plate 309 of the tag reader 300 is shown, for clarity and better understanding of this embodiment of the antennas internal in the tag reader 300, The antennas may be formed as longitudinal rectangle formed antennas being arranged at an angle α,−α pointing either backward or forward in regards of the path 311 a customer 312 can take through an exit/entry passage 310. This results in antenna footprints wherein a first footprint 6A″ is covering an area further inside the exit passage 310, and a second footprint covering an area further towards the outside of the exit passage 310. The footprint configuration illustrates in which direction the transmitted signal is sent 330A, 330B, 331C, and from what receiving direction 330A, 330B, 331A, 331B the antenna is optimized to receive.
   In FIG. 7A, the antennas 6A and 6B is used for both transmission and receiving, T/RX 330A, 330B. This means that for best performance the transmission and reception is advantageously time multiplexed, such that the first antenna is activated as a transmitting antenna for a ¼ of a set time period, as an receiver the next ¼ of the set time period, whereupon the second antenna repeat the transmit/receive cycle. This type of setup reduces the requirements to the hardware arranged to drive the antennas and analyze the received signals.
   In a further embodiment it is possible to duplicate the analyzing logic in order to send or receive simultaneously on both antennas.
   A further embodiment of an antenna setup is shown in FIG. 7C where a third antenna 6C is provided, and where the third antenna 6C is used for transmission. If the transmission frequency is different that the receiving frequency sent from the tags, the third antenna 6C may in principle transmit all the time, and the receiving antennas 6A, 6B may either receive 0.5 of the set time period each, or when an advanced receiving analyzing circuit is used the receiving antennas 6A, 6B may receive continuously.
   Non-moving tags 2 over a defined time period within the antenna reach may be considered to be commodity on display, and may optionally be excluded from detection until it is detected being on the move.
   Normally only tagged commodities being considered to exit the store will be analyzed. Optionally tagged commodities entering a store may be checked towards a whitelist and/or a blacklist.
   A Blacklist (not shown) may be established for enabling the sensor device to identify tagged commodities that has been stolen.
   A tag reader 300 comprising only a single antenna 6A, 6B may also be implemented, then, without the movement analysis capacity when used alone. An even further implementation in a shop exit area may comprise two or more tag readers 300, wherein one or more of the tag readers 300 may act as master tag readers 300, wherein the master tag reader 300 may use the antennas of other tag readers in its vicinity for collecting tag 2 information. Thus, multiple single antenna readers 300 may emulate/simulate dual antenna readers, and thus be able to calculate direction of movement and movement characteristics of a moving tag 2 of a tagged commodity 3.
   An even further embodiment of present invention comprise a multiple of tag readers 300, set up in a matrix type form to cover a larger area both in width and/or depth, and thus being able to for example establish more complex movement pattern, better reach and more secure identification of unique tags. This may be needed when tagged commodity 3 is carried together with multiple other tagged commodities, and longer reaction time available for synchronizing against networked backend resources is required.
   It is even within the inventive concept of present invention to arrange multiple tag readers 300 far apart, for example in different exit openings, and use these as combined signal feeding resources for one of the tag readers 300, like one or more master tag readers, to generate outputs and alerts.
   All tag readers 300 comprised in the sensor devices 1 of present disclosure may be one or multiple antenna devices, meaning the physical implementation comprise one or more antennas arranged with a distance in longitudinal 9, or perpendicular or other direction relative the longitudinal 9 detection path.
   Even a sensor device 1 comprising a single antenna tag reader 300 and being provided with advanced algorithms and signal processing resources may be able to detect tag movement pattern.
   A further solution for this scenario is to provide an antennas with configurable reach, a feature where a configuration module can configure the signal strength to range from 100 cm to 800 cm width. The depth d_{depth} of the covered area can for example be 50-100 cm reach depending for example on the size of the shop entrance, in order to have a tag reader reach covering the complete entrance, but not reaching all the way to commodities on display inside the store.

Features that may be comprised:
Sim card support for communicating between entities and backend
4G/5G communication support
Wifi/Bluetooth support, antennas and communication modules
Speaker, advanced and/or simple, preconfigures or configurable
LED lights, able to emit light pattern and warnings customized to corresponding alert signal
Light projector
CPU/microcontroller for advanced data analysis and communication, also AI modules
Physical communication interphase (connector) for example for diagnostic and/or sensor device 1 configuration
Local storage, for example an insertable SD card for local cache and data storage/manipulation, needed for example when communication line is down
Camera(s) 305, high and/or low resolution, single or multiple frame capacity
Power connector for power supply to sensor device 1, possibly provided through physical communication line, or contactless power charging device, using an on board power storage for mitigating power failure situation
On board software for operating, controlling and maintaining modules of sensor device 1
   As illustrated in FIG. 4A-C an advantageous placement of the device is right inside an outlet entrance, hanging from the roof in adjustable height wires or similar. This is subject to RFID antennas 6A, 6B reach and any other physical an technology constraints that may apply. The sensor device 1 should be located within sight of retail customers, to have a preventive effect on theft. In one embodiment of the invention the antenna coverage area and placement may be defined to be approx. 100 cm in depth d_{depth}, and at between 150-250 cm height hₘᵢₙ at the entire exit area. Subject to antennas 6A, 6B reach. The coverage area shall be able to detect products leaving a store, but not detecting products in other stores outside store perimeter, nor products inside the store.

As seen in FIG. 5 the feature helping visual communication is the “projected floor” feature. The idea is to project light down to the floor, a line of light suggesting a barrier, and with the possibility of displaying text on either side of the line. For example “Remember to pay before leaving” on the inside, catching customers exiting, and “Welcome to our store” on the outside, sending a message to customers entering the store.

The third aspect of this disclosure shows a system for verifying the status of a tagged commodity comprising: a sensor device according to any of the first aspect.

The system may further comprises: a remote computer environment 500, being one of a remote server or a cloud computing system, and the remote computer environment being adapted to maintain an article list 200 and/or a whitelist 400 of processed tagged commodities 3 and/or tags 2.

The sensor device 1 may be shipped preconfigured to a stores, and may be a “plug&play” type installation, be easy to mount, and self-supplied with all required connectivity both in first (FIG. 1) and second (FIG. 2) embodiment as described above.

Some features may be summed up to comprise, but not limited to:
Self-supplied low latency internet connection
Simultaneous RFID tag reading capabilities
Emit sound 306 and light 307 alerts upon detection of theft
High definition camera 305 for customer and theft analysis
Ability to project light 308 down to the floor below
OTA (over-the-air) software update capabilities

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1. A sensor device for defining the status of a tagged commodity comprising:
a tag associated with a commodity, the tag comprising an article descriptor, an article list comprising article descriptor entries representing tagged commodities in the article list,
a tag reader for reading the tag of a tagged commodity, and
a decision module able to verify if the article descriptor of the read tag of a tagged commodity is present in the article list.

2. The sensor device according to claim 1, further comprising:
a checkout module, wherein the checkout module provides the article descriptor entries representing tagged commodities in the article list, and the decision module is enabled to receive the article list from the checkout module.

3. The sensor device according to claim 2, wherein
the checkout module for processing tagged commodity being one or more of
Point of Sales, automatic or manually operated
Smart phone application, APP, and,
E-commerce system (1nn).

4. The sensor device according to claim 1, wherein
the tag reader comprise one or more antennas for transmission and reception of signals to/from the tag of a tagged commodity.

5. The sensor device according to claim 1, wherein
the tag is one of: an RFID tag, an NFC tag, and a custom built radio communication chip, the tag further comprise a unique tag id, and
the tag is enabled to communicate the tag id to the tag reader.

6. The sensor device according to claim 1, further comprising:
a whitelist comprising entries of unique tag ids identified by a tag reader and being associated with article descriptors that have been verified being present in an associated article list.

7. The sensor device according to claim 6, wherein
the decision module is enabled to verify, when an article descriptor of a read tag of a tagged commodity is identified not being present in the article list, whether the unique tag id is present in the whitelist.

8. The sensor device according to claim 1, wherein the decision module and the whitelist resides in a remote processing resource, such as a cloud computer resource or a remote server, and the sensor device and the checkout module is in communication connection with the remote processing resource.

9. The sensor device according to claim 6, wherein when a unique tag id of a read tag of a tagged commodity is verified being present in the article list, and the unique tag id is not present in the whitelist, the tag id is designated to a new list element in the whitelist.

10. The sensor device according to claim 6, further comprising:
a decision module comprising:
a first compare module for deciding whether the read tag of a tagged commodity is not present in the article list, and/or
a second compare for deciding whether the read tag of a tagged commodity is not present in the article list and the unique tag id of the read tag of a tagged commodity is not present in the whitelist.

11. The sensor device according to claim 1, further comprising an alarm device comprising one or more of:
an audio alarm,
a light alarm,
a push warning,
a camera, and
a light projector.

12. The sensor device according to claim 10, wherein the compare modules initiates an activation code for one or more of:
initiating a whitelist or article list check process
sounding an audio alarm
activating a light alarm
sending a push warning,
operating a camera, and
activating a light projector.

13. The sensor device according to claim 11, wherein the light projector comprising a message projecting device.

14. The sensor device according to claim 1, wherein
the tag reader is arranged to monitor an exit passage located downstream of the checkout module, such that a customer purchasing one or more tagged commodities must pass the checkout module before passing the tag reader.

15. The sensor device according to claim 1, wherein the decision module is enabled to receive data from remote sensor devices related to tag associated with a commodity being detected and/or analyzed by any of the remote sensor devices.

16. The sensor device according to claim 1, wherein the tag reader is arranged to hang above an exit passage and has a form and size easily spotted and identifiable by passing customers, such as for example, but not bound to:
a half cut upside down hanging spherical form,
tube like form.

17. A method for verifying the status of a tagged commodity comprising the following steps:
using a sensor device according to claim 1,
processing a tagged commodity by reading, by a tag reader, the article descriptor of a tag,
performing a first compare to decide whether the tag article descriptor is associated with an entry in an article list, and
update a first alert status for the read tag, to:
active; if tag article descriptor is not found in the article list, and
passive; if it is found in the article list.

18. The method according to claim 17, the method comprising the further steps:
when the first alert status is active:
performing a first compare to decide whether the tag id of the read tag with tag id entries in a whitelist, and
if read tag id is not found in the whitelist perform one or more of:
set a second alert to active status, and
activate one or more of:
a silent alarm registration process
an audio alarm,
a light alarm,
a push warning,
a camera, and
a light projector.

19. The method according to claim 17, the method comprising the further steps:
when the first alert status is passive:
generate a new designated list elements 401 in a whitelist with the tag id of the read tag.

20. A system for verifying the status of a tagged commodity comprising:
a sensor device according to claim 1.

21. The system according to claim 20, further comprising:
a remote computer environment, being one of a remote server or a cloud computing system, and the remote computer environment being adapted to maintain an article list and/or a whitelist of processed tagged commodities and/or tags.
